(19) United States
(12) Patent Application Publication
(10) Pub. No.: US 2015/0325829 A1
(43) Pub. Date: Nov. 12, 2015

(54) SEPARATOR HAVING HIGH ELECTROLYTE WETTABILITY FOR SECONDARY BATTERY AND METHOD OF MANUFACTURING THE SAME

(71) Applicant: TOPTEC HNS CO., LTD., Gyeongsangbuk-do (KR)

(72) Inventor: Hyang Doo LEE, Busan (KR)

(21) Appl. No.: 14/369,156

(22) PCT Filed: Feb. 18, 2013
(86) PCT No.: PCT/KR13/01246

§ 371 Date: Jun. 26, 2014

(30) Foreign Application Priority Data
Jan. 25, 2013 (KR) 10-2013-0008513

(51) Int. Cl. H01M 2/16; H01M 2/14

(52) U.S. Cl. CPC H01M 2/1686; H01M 2/1653; H01M 2/162; H01M 2/145

(57) ABSTRACT

Provided is a separator having high wettability for a secondary battery, including a polyolefin substrate, a nanofiber hot melt layer formed on one or both surfaces of the substrate, and a nanofiber electrolyte wetting layer formed on the hot melt layer, wherein the hot melt layer is applied in an amount of 0.05˜2.5 g/m², and the electrolyte wetting layer has a porosity of 55˜89%. The separator according to the current invention has superior heat resistance and high mechanical strength and can exhibit a shutdown function, and has superior porosity and pore size so as to be adapted for a separator for a secondary battery, thereby manifesting high ionic conductivity and preventing battery performance from deteriorating.

### BACKGROUND

The present invention relates to a separator having high electrolyte wettability for a secondary battery, and to a method of manufacturing the same.

Secondary batteries, such as lithium ion secondary batteries, lithium polymer secondary batteries and super capacitors (electric double-layer capacitors and similar capacitors), are required to have high energy density, large capacity and thermal stability depending on the demand trends of high performance, lightness, and large scale for power sources for vehicles.

However, conventional lithium ion secondary batteries using a polyolefin separator and a liquid electrolyte, and conventional lithium ion polymer batteries using a gel polymer electrolyte membrane or a polyolefin separator gel-coated with a polymer electrolyte, have heat resistance inadequate for use as batteries having high energy density and high capacity.

A separator is positioned between the cathode and the anode of a battery to thus be responsible for an insulation function, and maintains an electrolyte to provide an ionic conduction path. Furthermore, when the temperature of the battery is excessively increased, the separator exhibits a shutdown function in such a way that part of the separator is melted to thus close pores in order to block the flow of current. If the separator is melted due to further increased temperature, a large hole is formed, and short-circuit may occur between the cathode and the anode. This temperature is referred to as a short-circuit temperature. Generally, it is preferred that a separator have a low shutdown temperature and a higher short-circuit temperature. In the case of a polyethylene separator, the short-circuit temperature approximates to 140° C. upon overheating of the battery.

With the goal of manufacturing a secondary battery having high energy density and large capacity with a higher short-circuit temperature, a separator is required, which has high heat resistance and thus low thermal shrinkage, and high ionic conductivity and thus superior cycle performance.

To obtain such a separator, US Patent Publication No. 2006/0019154 discloses preparation of a polyolefin separator coated with a porous heat-resistant resin, such as polyimide, polyimide or polyamideimide, having a melting temperature of 180° C. or more.

Japanese Patent Application Publication No. 2005-209570 discloses preparation of a polyolefin separator coated with a heat-resistant resin by coating both surfaces of a polyolefin separator with a heat-resistant resin solution including aromatic polyimide, polyimide, polyethersulfone, polyetherketone or polyetherimide, having a melting temperature of 200° C. or more, and then performing immersion in a coagulant, water washing and drying. As such, a phase separation agent for imparting porosity is added to the heat-resistant resin solution in order to reduce a decrease in ionic conductivity, and the amount of applied heat-resistant resin is limited to 0.5˜6.0 g/m².

However, immersion in the heat-resistant resin or coating with the heat-resistant resin may close pores of the polyolefin separator, and thus the movement of lithium ions is limited, undesirably deteriorating charge-discharge properties. Therefore, the separator and the electrolyte membrane as disclosed conventionally do not satisfy both heat resistance and ionic conductivity, and the heat-resistant coating may result in deteriorated output properties. Thus, they are difficult to use for batteries having high energy density and large capacity such as batteries for power sources of vehicles, which require superior performance under severe conditions such as rapid charge-discharge, as well as heat resistance.

### SUMMARY OF THE INVENTION

An object of the present invention is to provide a separator for a secondary battery, which has high electrolyte wettability and high short-circuit temperature.

Another object of the present invention is to provide a method of manufacturing a separator for a secondary battery.

In order to accomplish the above objects, the present invention provides a separator for a secondary battery, which has high electrolyte wettability and high short-circuit temperature.

Also, the present invention provides a method of manufacturing a separator for a secondary battery.

According to the present invention, a separator for a secondary battery includes an electrolyte wetting layer, and thus can exhibit high electrolyte wettability and superior heat resistance, and the substrate layer and the electrolyte wetting layer are adhered to each other by means of a small amount of a hot melt layer, thus manifesting superior adhesive strength and dimensional stability. Furthermore, the electrolyte wetting layer and the hot melt layer are composed of nanofibers by way of continuous electrospinning, thereby forming fine pores and preventing a reduction in strength and tangling of fibers, ultimately obtaining a separator for having uniform pores and porosity.

### DETAILED DESCRIPTION OF THE INVENTION

Unless otherwise defined, all the technical terms used herein have the following definitions and correspond to the meanings as generally understood by those skilled in the art. Also, preferred methods or samples are described herein, but those similar or equivalent thereto are incorporated in the scope of the invention. The contents of all the publications disclosed as references herein are incorporated in the present invention.

The term “about” means the amount, level, value, number, frequency, percent, dimension, size, quantity, weight or length changed by 30, 25, 20, 15, 10, 9, 8, 7, 6, 5, 4, 3, 2 or 1% relative to the referred amount, level, value, number, frequency, percent, dimension, size, quantity, weight or length.

Throughout the description, unless otherwise stated, the term “comprises or includes” and/or “comprising or including” used herein shall be construed as indicating the presence of steps or elements described herein, or the group of steps or elements, but should be understood so as not to exclude presence or additional probability of any other steps or elements, or the group of steps or elements.

Hereinafter, a detailed description will be given of the present invention.

The present invention addresses a separator for a secondary battery, which is configured such that a hot melt layer and an electrolyte wetting layer, composed of nanofibers of a hot melt resin, are formed on one or both surfaces of a polyolefin substrate.

The polyolefin separator substrate is mainly provided in the form of a porous film, and has low melting temperature. When the temperature of a battery is about 140° C., a shutdown function is disclosed, but when the temperature thereof is further increased, the separator may be melted and thus short-circuit occurs and thermal runaway may also occur. Hence, although various heat-resistant separators are being developed, when the olefin separator is coated with heat-resistant fibers, adhesive strength and porosity may decrease undesirably. Thus, in the present invention, while the adhesive layer is minimized thanks to the use of the hot melt layer, the electrolyte wetting layer is formed, and the hot melt layer is applied in an amount of 0.05˜2.5 g/m², and the electrolyte wetting layer has a porosity of 55˜89%.

Polyolefin Substrate Layer

The polyolefin substrate is a separator material which is the most commonly used for a non-aqueous secondary battery, and examples thereof may include materials and products typically used in the art. For instance, useful is a material selected from among polyethylene (PE), polypropylene (PP), high-density polyethylene (HDPE), ultra high modulus polyethylene (UHMPE) and mixtures of two or more thereof. The polyolefin substrate may be provided in the form of a monolayer or a multilayer having two or more layers, and in the monolayer or multilayer structure, the total thickness is preferably set to about 10˜30 μm, but is not limited thereto.

For example, the substrate layer may be composed exclusively of PE or PP, but includes a monolayer structure composed of a thin film layer comprising a mixture of PE and PP or a multilayer structure including a PE layer and a PP layer. In some cases, the polyolefin substrate according to the present invention may contain a resin in an amount of less than 30% for modifying various properties within a range that does not change the properties of a polyolefin resin, and the polyolefin thin film layer thus modified may be incorporated in the scope of the present invention.

The preparation of the polyolefin substrate is not limited, and is classified into a wet method and a dry method depending on the use of a solvent. The dry method is performed by subjecting a crystalline polyolefin polymer material to melt extrusion and molding to form a planar sheet, which is then thermally treated and stretched at low temperature and high temperature to form pores, thereby manufacturing a separator. The dry method which obviates the solvent has a simple process and high productivity but is difficult to prepare products having a wide dimension and is disadvantageous because of non-uniform thickness of the separator and directional dependency of mechanical strength by uniaxial stretch. Examples of the commercially available polyolefin substrate manufactured by the dry method may include Celgard series from Celgard, U-Pore series from Ube, and products from CS TECH.

The wet method is performed by mixing a polyolefin polymer material with a low-molecular-weight organic material (a pore forming agent) such as fluid paraffin or solid wax, followed by heat melting in an extruder and passing through a T-die and a casting roll to form a sheet, which is then stretched at a temperature near a crystal melting temperature, washing the sheet using a non-volatile solvent, removing the solvent residue, and performing drying/thermal treatment, thus forming a pore structure. The wet method is advantageous because of superior mechanical strength due to biaxial stretch, and a pore structure having long and densely connected pores, but suffers from a complicated preparation process. Examples of the commercially available polyolefin substrate manufactured by the wet method may include HiPore from Asahi Kasei, Setela from Tonen, Enpass from SK Innovation, etc.

Hot Melt Layer

The hot melt layer, which is a porous thin film comprising nanofibers by electrospinning a hot melt resin, is formed on one or both surfaces of the polyolefin substrate layer.

The hot melt layer according to the present invention is formed using an electrospinning process, and is applied in a small amount of 0.05˜2.5 g/m² per unit area, thus preventing ionic mobility or electrolyte wettability from decreasing due to the formation of the adhesive layer.

In the present invention, the hot melt resin composition indicates a resin composition obtained by dissolving a solid material in a solvent, electrospinning the solution to form nanofibers which are then melted by heat so as to exhibit adhesion. The hot melt resin of the invention having such properties is not particularly limited so long as it has ionic conductivity and does not have a negative influence on battery performance. This resin may be a resin having a melting temperature ranging from 70° C. to less than 135° C., and specific examples thereof may be selected from among epoxy, vinylacetate, vinylchloride, polyvinylacetal, acryl, unsaturated polyester, saturated polyester, polyamide, polyolefin, urea, melamine, phenol, resorcinol, polyvinylalcohol, butadiene rubber, nitrile rubber, butyl rubber, silicone rubber, vinyl, phenol-chloroprene rubber, rubber-epoxy resin or mixtures of two or more thereof, copolymers, graft copolymers, and compound materials through general chemical modification, but are not limited thereto. In a preferred embodiment, the hot melt resin may be selected from among epoxy, polyethylene, polypropylene, ethylenevinylacetate (EVA), polyester, polyamide resin and mixtures thereof.

In the present invention, the hot melt resin composition for electrospinning may include various additives adapted therefor, including one or two solvents for dissolving a solid component to form a liquid or for efficiently forming hot melt nanofibers upon applying a high voltage in the electrospinning process, an additive for adjusting electrical conductivity, an antistatic agent for removing static electricity, a slip agent for adjusting viscosity of the hot melt, etc.

The thickness of the hot melt layer is not particularly limited. This layer preferably has low thickness and high porosity in consideration of battery performance, and for example, it is about 0.04˜2.0 μm thick, and is provided in the form of a monolayer or a multilayer. The hot melt layer of the invention has low electric resistance, and may prevent the performance of a secondary battery from decreasing when applied to such a battery. If the thickness of the hot melt layer is less than 0.04 μm, adhesive strength may become weak and thus the olefin substrate layer and the electrolyte wetting layer are easily separated from each other. In contrast, if the thickness thereof exceeds 2.0 μm, the hot melt layer may become thick and thus air permeability and porosity are remarkably lowered, undesirably deteriorating the performance of the separator.

In the present invention, the hot melt layer is formed by way of electrospinning. The electrospinning process is not particularly limited and may be modified so as to be adapted for the present invention based on the manner known in the art. For example, the electrospinning process may include the steps of applying a voltage to prepare an electrically charged spinning solution, extruding the charged spinning solution through a spinning nozzle to give nanofibers, and integrating the nanofibers on a collector having the charge opposite to that of the spinning solution. The electrospinning process is advantageous in terms of easy formation of fibers having a nano-size diameter.

In an embodiment, the hot melt layer preferably comprises nanofibers having an average diameter of about 50˜900 nm. If the average diameter of the nanofibers is less than about 50 nm, air permeability of the separator may decrease. In contrast, if the average diameter thereof exceeds about 900 nm, it is not easy to adjust the pore size and the thickness of the separator.

Electrolyte Wetting Layer

In the present invention, the electrolyte wetting layer is formed on the surface of the separator using a resin having high electrolyte wettability so as to be suitable for use in a separator for a secondary battery. The resin having high electrolyte wettability is preferably a resin having a melting temperature of 110˜400° C. When this resin is used, electrolyte wettability of the separator may increase and short-circuit temperature of the separator may increase, thereby ensuring heat resistance of a battery. Specific examples of the resin may be selected from the group consisting of polyimide (PI), aramid, polytetrafluoroethylene (PTFE), polychlorotrifluoroethylene (PCTFE), polyvinylidenefluoride (PVDF), polyvinylidenefluoride-hexafluoropropylene (PVDF-HFP) and mixtures thereof.

The thickness of the electrolyte wetting layer is not particularly limited, and may be, for example, about 0.2˜7 μm, and this layer may be provided in the form of a monolayer or a multilayer. If the thickness of the electrolyte wetting layer is less than 0.2 μm, improvements in electrolyte wettability may become insignificant. In contrast, if the thickness thereof exceeds 7 μm, air permeability may decrease and the separator may become thick.

The electrolyte wetting layer preferably comprises nanofibers having an average diameter of about 50˜900 nm. If the average diameter of the nanofibers is less than about 50 nm, air permeability may decrease. In contrast, if the average diameter thereof exceeds about 900 nm, layer thickness may become non-uniform.

The separator according to the present invention may be utilized in an electrochemical device, especially a separator for a lithium secondary battery, and makes it possible to manufacture a battery having high heat resistance, good electrolyte wettability and surface properties, and high permeability with high performance and safety.

Method of Manufacturing Separator

The present invention provides a method of manufacturing a separator having high wettability for a secondary battery, including the following steps:

(1) subjecting a hot melt resin to primary electrospinning on one or both surfaces of a polyolefin substrate to form a hot melt layer comprising nanofibers;

(2) subjecting a resin having high electrolyte wettability to secondary electrospinning on the hot melt layer formed in (1) to form an electrolyte wetting layer comprising nanofibers, thus manufacturing a stack sheet; and

(3) heat pressing the stack sheet to impart adhesive strength by hot melt.

In the method according to the present invention, two electrospinnings are performed on a polyolefin substrate to thus form the hot melt layer and the electrolyte wetting layer, after which the resin of the hot melt layer is melted by heat pressing, whereby the substrate and the electrolyte wetting layer are adhered to each other.

It is preferred that the polyolefin substrate be continuously supplied, and that the two electrospinnings be sequentially continuously performed.

In step (1), primary electrospinning may be carried out by electrospinning a composition including the hot melt resin. Such a hot melt resin composition may be provided in the form of a solution in which 10˜20 wt % of the hot melt resin is dissolved in a solvent, and added with an additive such as a conductivity controller, a viscosity controller, etc. In a preferred embodiment, the composition has a viscosity of 300˜800 cps, and an electrical conductivity of 6.0˜12.0 ms/cm. The hot melt resin is as mentioned above, and may include, but is not limited to, HM7150PS, OB900, OK370, etc. as EVA type resin from Okong used in the examples of the present invention.

In step (2), secondary electrospinning may be carried out by electrospinning a composition including the resin having high electrolyte wettability. Such a resin composition may be provided in the form of a solution in which 10˜25 wt % of the resin having high electrolyte wettability is dissolved in a solvent, and added with an additive such as a conductivity controller, a viscosity controller, etc. In a preferred embodiment, the composition has a viscosity of 300˜700 cps, and an electrical conductivity of 15˜30 ms/cm. The resin having high electrolyte wettability is as mentioned above, and may include, but is not limited to, KYNAR PVDF 710 as PVDF resin from ARKEMA used in the examples of the present invention.

In steps (1) and (2), as the electrospinning time increases, the layer thickness of the nanofibers is increased. The thicknesses of the hot melt layer and the electrolyte wetting layer may be adjusted by controlling the electrospinning time. For example, the thickness of the hot melt layer may be set to 0.04˜2.0 μm, and preferably 0.2˜1.0 μm under the condition of the spinning time of 1˜5 min.

In step (3), heat pressing is preferably performed at a melting temperature of the hot melt resin ±20° C. At a temperature lower by −20° C. than the melting temperature of the hot melt resin, adhesive function of the hot melt nanofibers cannot be exhibited. In contrast, if heat pressing is performed at a temperature higher by 20° C. than the melting temperature of the hot melt resin, the olefin separator may thermally shrink, and the hot melt nanofibers are excessively melted, undesirably deteriorating adhesive strength and air permeability.

### EXAMPLES

A better understanding of the present invention may be obtained through the following examples which are set forth to illustrate, but are not to be construed to limit the present invention, which will be apparent to those skilled in the art.

<Evaluation Method>

1. Punching Strength

To measure punching strength, a sample is spread and fixed to a test frame. The fixed sample is applied to a needle having a diameter of 1 mm under a force of 1 kgf until it is punched. The value when the sample is punched is recorded in the unit of gf. Ten measurements per sample are performed and the average value is determined.

2. Air Permeability

Air permeability is measured under conditions that the pressure is set to 600 Pa and the measurement unit is represented as cm³/cm²/s. A sample is cut to a width of 100 mm and a length of 100 mm without being crumpled. Three points per 100 mm wide/long sample are measured in a direction from the left diagonal line toward the right bottom using an air permeability meter, and the average value is determined.

3. Thermal Stability (Thermal Shrinkage)

Three samples having a size of 140 mm×60 mm are prepared and crosslines are drawn at 100 mm in a length direction and 40 mm in a width direction. The test temperature is set, and when an oven reaches the set temperature and thus is maintained in temperature, the sample is placed in the oven and allowed to stand for 60 min, taken out of the oven and then allowed to stand at room temperature for 10 min. The decreased length of the crosslines compared to the length of the crosslines before testing is measured, and a thermal shrinkage is calculated.

Thermal shrinkage (%): (initial length−length after oven testing)/initial length×100

4. Adhesive Strength

A sample is cut to a width of 25 mm and a length of 100 mm and ends of 10 mm are then separated. The sample is fixed to both jigs using an adhesive strength meter and measurement is carried out at a speed of 30 m/min. As such, the unit is gf or kgf, and ten measurements per sample are performed and thus the average value is determined.

5. Uptake (%)

A separator sample is cut to a width of 5 cm and a length of 5 cm, and immersed in an electrolyte for 5 min, and the remaining electrolyte is removed from the surface thereof, and the weight of the separator is measured.

Uptake (%)=(total weight after immersion in electrolyte−weight of sample)/(weight of sample)×100

### Preparative Example 1

### First Electrospinning Composition Having Hot Melt Property

As a hot melt resin, an EVA type resin under a brand name of HM7150PS from Okong was added in an amount of 20% based on the weight of a xylene solvent, and heated up to 40° C. by 2˜3° C. per min with stirring at 1000 rpm using a stirrer. After completion of the heating up to 40° C., the solution was stirred for 6 hr, so that the EVA resin was completely dissolved in the xylene solvent. The solution was cooled to 25° C., added with 0.3% of a conductivity controller and 3% of a viscosity controller (VISCOBYK-15130, BYK), and stirred for 1 hr, thus preparing a first electrospinning composition. The composition had a viscosity of 600 cps and an electrical conductivity of 9 ms/cm.

### Preparative Example 2

### First Electrospinning Composition Having Hot Melt Property

A first electrospinning composition was prepared in the same manner as in Preparative Example 1, with the exception that the hot melt resin was added in an amount of 15% based on the weight of the xylene solvent, and added with 1% of a conductivity controller and 5% of a viscosity controller (VISCOBYK-15130, BYK). The composition had a viscosity of 350 cps and an electrical conductivity of 15 ms/cm.

### Preparative Example 3

### First Electrospinning Composition Having Hot Melt Property

A first electrospinning composition was prepared in the same manner as in Preparative Example 1, with the exception that the hot melt resin was added in an amount of 23% based on the weight of the xylene solvent, and added with 0.1% of a conductivity controller and 1% of a viscosity controller (VISCOBYK-15130, BYK). The composition had a viscosity of 1200 cps and an electrical conductivity of 2.4 ms/cm.

### Preparative Example 4

### Second Electrospinning Composition Having High Wettability

As a resin having high wettability, KYNAR PVDF 710 from ARKEMA was used. KYNAR PVDF 710 was added in an amount of 19% based on the weight of a solvent to a solvent of DMF and acetone mixed at a ratio of 7:3 and heated up to 30° C. by 2˜3° C. per min with stirring at 1000 rpm using a stirrer. After completion of the heating up to 30° C., the solution was stirred for 8 hr, so that PVDF was completely dissolved in the mixed solvent of DMF and acetone. The solution was cooled to 25° C., added with 0.5% of a conductivity controller, and stirred for 1 hr, thus preparing a second electrospinning composition. This solution had a viscosity of 650 cps and an electrical conductivity of 24 ms/cm.

### Example 1

1-1. A poyolefin substrate (Celgard 2320, Celgard, USA) was attached to a collector of an electrospinning device using a tape without being crumpled.

1-2. The electrospinning composition having hot melt property of Preparative Example 1 was fed to an electrospinning nozzle and electrospun for 5 min under conditions of high voltage (22 KV), TCD of 11 cm, a temperature of 25° C. and a humidity of 28%, thus forming a hot melt layer on the polyolefin substrate. The hot melt layer was 1 μm thick and was applied in an amount of 1.25 g/m² per unit area, and hot melt nanofibers had an average fiber diameter of 200 nm.

1-3. The second electrospinning composition having high wettability of Preparative Example 4 was electrospun on the hot melt layer using an electrospinning device for 3 min 30 sec under conditions of high voltage (28 KV), TCD of 12 cm, a temperature of 25° C. and a humidity of 25%, thus forming an electrolyte wetting layer. The electrolyte wetting layer had a thickness of 1 μm, and was composed of nanofibers having an average fiber diameter of 300 nm, with a porosity of 87%.

1-4. The manufactured stack sheet was subjected to heat pressing under conditions of a roll temperature of 90° C. and a pressure of 100 kgf/cm using a roll calendaring testing machine, thus manufacturing a sample having a final thickness of about 22˜23 μm.

### Example 2

A sample was manufactured in the same manner as in Example 1, with the exception that the hot melt layer was formed by performing the electrospinning for 10 sec using the electrospinning composition of Preparative Example 1. The hot melt layer had a thickness of 0.03 μm, and was applied in an amount of 0.038 g/m² per unit area, and hot melt nanofibers had an average fiber diameter of 200 nm.

### Example 3

A sample was manufactured in the same manner as in Example 1, with the exception that the hot melt layer was formed by performing the electrospinning for 30 min using the electrospinning composition of Preparative Example 1. The hot melt layer had a thickness of 3.0 μm, and was applied in an amount of 3.75 g/m² per unit area, and hot melt nanofibers had an average fiber diameter of 200 nm.

### Example 4

A sample was manufactured in the same manner as in Example 1, with the exception that the hot melt layer was formed by performing the electrospinning for 25 min using the electrospinning composition of Preparative Example 2. The hot melt layer had a thickness of 1 μm, and was applied in an amount of 1.5 g/m² per unit area, and hot melt nanofibers had an average fiber diameter of 42 nm.

### Example 5

A sample was manufactured in the same manner as in Example 1, with the exception that the hot melt layer was formed by performing the electrospinning for 1 min using the electrospinning composition of Preparative Example 3. The hot melt layer had a thickness of 1 μm, and was applied in an amount of 0.9 g/m² per unit area, and hot melt nanofibers had an average fiber diameter of 1130 nm.

### Test Example 1

Air permeability, punching strength, adhesive strength, uptake and thermal stability tests of the separators of Examples 1 to 5 and a commercially available separator (Celgard® 2320) 20 μm from Celgard, USA, were carried out. The results are shown in Table 1 below.

TABLE 1

| | | | | | Thermal stability | | | | | |
|---|---|---|---|---|---|---|---|---|---|---|
| | | | | | (shrinkage %) | | | | | |
| | Air | Punching | Adhesive | | 95° C. | | 105° C. | | 120° C. | |
| | permeability | strength | strength | Uptake | MD | TD | MD | TD | MD | TD |
| Ex. 1 | ⊚ | ⊙ | ⊚ | ⊚ | ⊚ | ⊚ | ⊙ | ◯ | Δ | Δ |
| Ex. 2 | ⊚ | ⊙ | X | ⊚ | ⊚ | ⊚ | ⊙ | ◯ | Δ | Δ |
| Ex. 3 | X | ⊙ | ⊚ | ⊙ | ⊚ | ⊚ | ⊙ | ◯ | Δ | Δ |
| Ex. 4 | X | ⊚ | ⊚ | ⊚ | ⊚ | ⊚ | ⊙ | ◯ | Δ | Δ |
| Ex. 5 | Δ | ⊙ | Δ | ⊙ | ⊚ | ⊚ | ⊙ | ◯ | Δ | Δ |
| Celgard | ⊚ | ◯ | — | X | ⊚ | ⊚ | ◯ | Δ | X | X |
| Separator | | | | | | | | | | |

excellent: ⊚
good: ⊙
fair: ◯
poor: Δ
very poor: X

Although the preferred embodiments of the present invention have been disclosed for illustrative purposes, those skilled in the art will appreciate that various modifications, additions and substitutions are possible, without departing from the scope and spirit of the invention as disclosed in the accompanying claims. The disclosed embodiments should be taken into consideration not from limited point of view but from descriptive point of view. The scope of the present invention is shown not in the above description but in the claims, and all differences within the range equivalent thereto will be understood to be incorporated in the present invention.

1. A separator having high wettability for a secondary battery, comprising:
a polyolefin substrate for a separator for a secondary battery;
a nanofiber hot melt layer formed by electrospinning a hot melt resin composition on one or both surfaces of the polyolefin substrate; and
a nanofiber electrolyte wetting layer formed by electrospinning a resin having high electrolyte wettability on the nanofiber hot melt layer,
wherein the hot melt layer is applied in an amount of 0.05˜2.5 g/m², and
the electrolyte wetting layer has a porosity of 55˜89%.

2. The separator of claim 1, wherein the polyolefin substrate comprises a material selected from among polyethylene, polypropylene, high-density polyethylene (HDPE), ultra high modulus polyethylene (UHMPE) and mixtures thereof.

3. The separator of claim 1, wherein the hot melt resin has a melting temperature ranging from 70° C. to less than 135° C.

4. The separator of claim 3, wherein the hot melt resin is selected from the group consisting of epoxy, vinylacetate, vinylchloride, polyvinylacetal, acryl, unsaturated polyester, saturated polyester, polyamide, polyolefin, urea, melamine, phenol, resorcinol, polyvinylalcohol, butadiene rubber, nitrile rubber, butyl rubber, silicone rubber, vinyl, phenol-chloroprene rubber, rubber-epoxy resin and mixtures thereof.

5. The separator of claim 4, wherein the hot melt resin is selected from the group consisting of epoxy, polyethylene, polypropylene, ethylenevinylacetate (EVA), polyester, polyamide resin and mixtures thereof.

6. The separator of claim 1, wherein the resin having high electrolyte wettability is a resin having a melting temperature of 110˜400° C.

7. The separator of claim 6, wherein the resin having high electrolyte wettability is selected from the group consisting of polyimide (PI), aramid, polytetrafluoroethylene (PTFE), polychlorotrifluoroethylene (PCTFE), polyvinylidenefluoride (PVDF), polyvinylidenefluoride-hexafluoropropylene (PVDF-HFP) and mixtures thereof.

8. The separator of claim 1, wherein the hot melt layer comprises hot melt resin nanofibers having a diameter of 50˜900 nm, and the electrolyte wetting layer comprises polymer nanofibers having high electrolyte wettability with a diameter of 50˜900 nm.

9. The separator of claim 1, wherein the hot melt layer is 0.04˜2.0 μm thick, and the electrolyte wetting layer is 0.2˜7 μm thick.

10. A method of manufacturing the separator for a secondary battery of claim 1, comprising:
(1) subjecting a composition including a hot melt resin to primary electrospinning on one or both surfaces of a polyolefin substrate to form a hot melt layer comprising nanofibers;
(2) subjecting a composition including a resin having high electrolyte wettability to secondary electrospinning on the hot melt layer formed in (1) to form an electrolyte wetting layer comprising nanofibers, thus manufacturing a stack sheet; and
(3) heat pressing the stack sheet to impart adhesive strength by hot melt.

11. The method of claim 10, wherein the polyolefin substrate comprises a material selected from among polyethylene, polypropylene, high-density polyethylene (HDPE), ultra high modulus polyethylene (UHMPE) and mixtures thereof.

12. The method of claim 10, wherein the hot melt resin is selected from the group consisting of epoxy, polyethylene, polypropylene, ethylenevinylacetate (EVA), polyester, polyamide resin and mixtures thereof.

13. The method of claim 10, wherein the resin having high electrolyte wettability is selected from the group consisting of polyimide (PI), aramid, polytetrafluoroethylene (PTFE), polychlorotrifluoroethylene (PCTFE), polyvinylidenefluoride (PVDF), polyvinylidenefluoride-hexafluoropropylene (PVDF-HFP) and mixtures thereof.

14. The method of claim 10, wherein the polyolefin substrate is continuously supplied, and the primary electrospinning and the secondary electrospinning are sequentially continuously performed.

15. The method of claim 10, wherein the heat pressing is performed at a melting temperature of the hot melt resin ±20° C.

16. The method of claim 10, wherein the composition including the hot melt resin has a viscosity of 300˜800 cps and an electrical conductivity of 6.0˜12.0 ms/cm, and the composition including the resin having high electrolyte wettability has a viscosity of 300˜700 cps and an electrical conductivity of 15.0˜30.0 ms/cm.

17. The method of claim 10, wherein the hot melt layer and the electrolyte wetting layer are adjusted in thickness by controlling a spinning time.
